(19) United States
(12) Patent Application Publication
(10) Pub. No.: US 2011/0193828 A1
(43) Pub. Date: Aug. 11, 2011

(54) TELESCOPING STYLUS FOR PORTABLE ELECTRONIC DEVICE

(75) Inventors: YU QIU, Shenzhen City (CN); JUN-LIN CHEN, Shenzhen (CN); YUNG-CHANG YEN, Shindian (TW)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/902,226

(22) Filed: Oct. 12, 2010

(30) Foreign Application Priority Data
Feb. 9, 2010 (CN) 201010301427.7

(51) Int. Cl. G06F 3/033

(52) U.S. Cl. 345/179

(57) ABSTRACT

A stylus includes a housing, a core, a pole and a positioning member. The core is slidably received in the housing. The pole is secured in the housing. The pole includes a first ring groove and a second ring groove. The positioning member is mounted to the core. A plurality of arcuate portions is formed on the positioning member. The arcuate portions are selectably engaged in the first ring groove and the second ring groove to position the stylus at different positions.

### BACKGROUND

1. Technical Field

The present disclosure relates to styluses, and more particularly to a telescoping stylus for a portable electronic device (e.g., mobile phone).

2. Description of Related Art

Styluses are used as input devices for writing, marking, or pressing on pressure-sensitive screens.

Styluses are usually stored on or in an electronic device, and so are made small. For many people it is difficult to easily and accurately manipulate small styluses, therefore telescoping styluses have come into use. However, conventional telescoping styluses are positioned in a closed state or a fully extended state by friction. When the telescoping styluses are used for a period of time, the friction may lessen and the telescoping styluses are not so easily maintained in either of the two different positions. Thus, it is not suitable or comfortable for everyone.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present stylus for portable electronic device. Moreover, in the drawings, like reference numerals designate corresponding parts throughout the several views.

FIG. 1 is an exploded, isometric view of an exemplary stylus used for portable electronic device.

FIG. 2 is an assembled, isometric view of the exemplary stylus.

FIG. 3 is a cross-sectional view of FIG. 2 taken along line III-III.

FIG. 4 is a fully extended state view of the exemplary stylus.

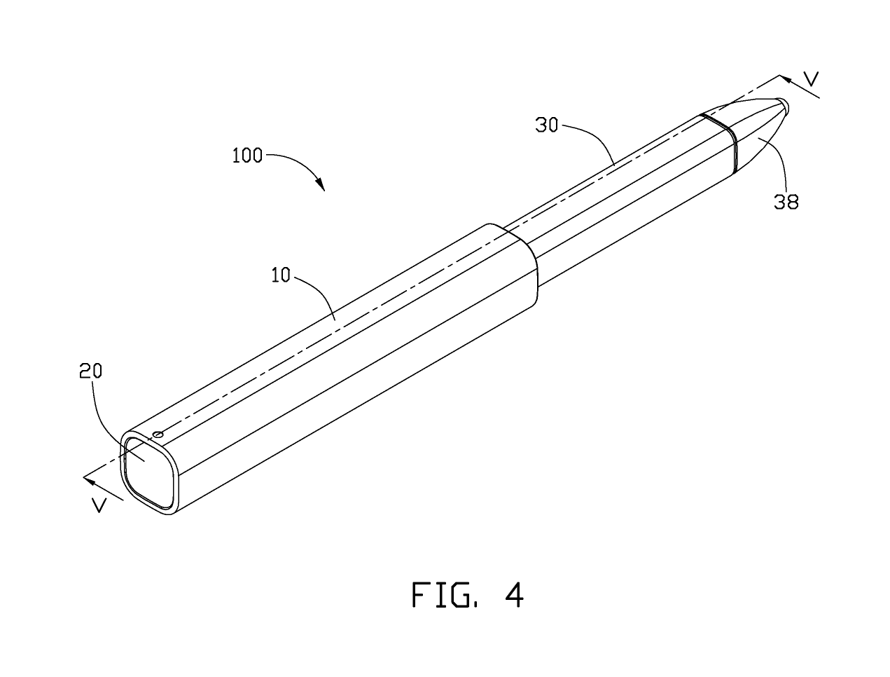

FIG. 5 is a cross-sectional view of FIG. 4 taken along line V-V.

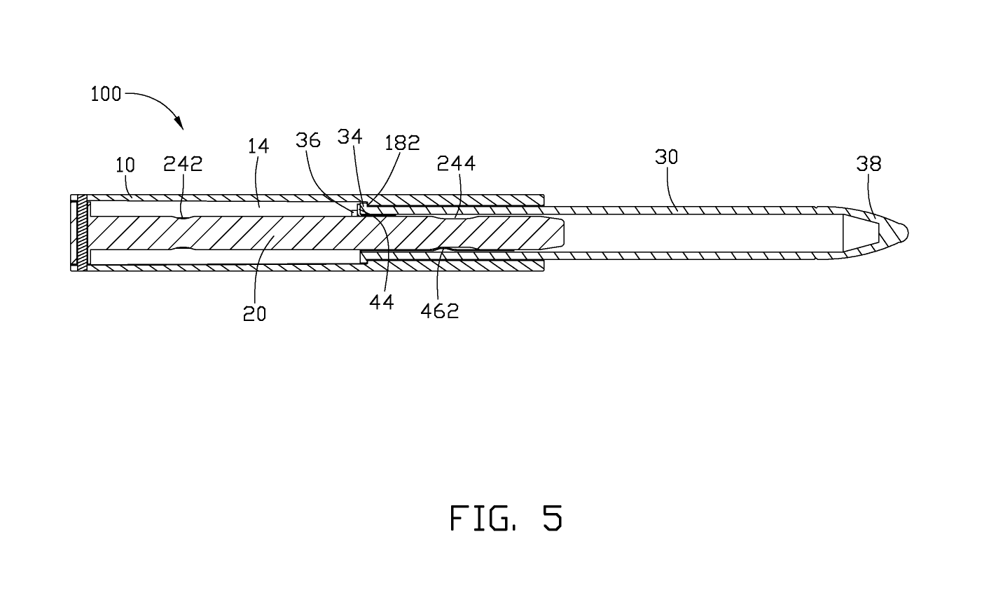

### DETAILED DESCRIPTION

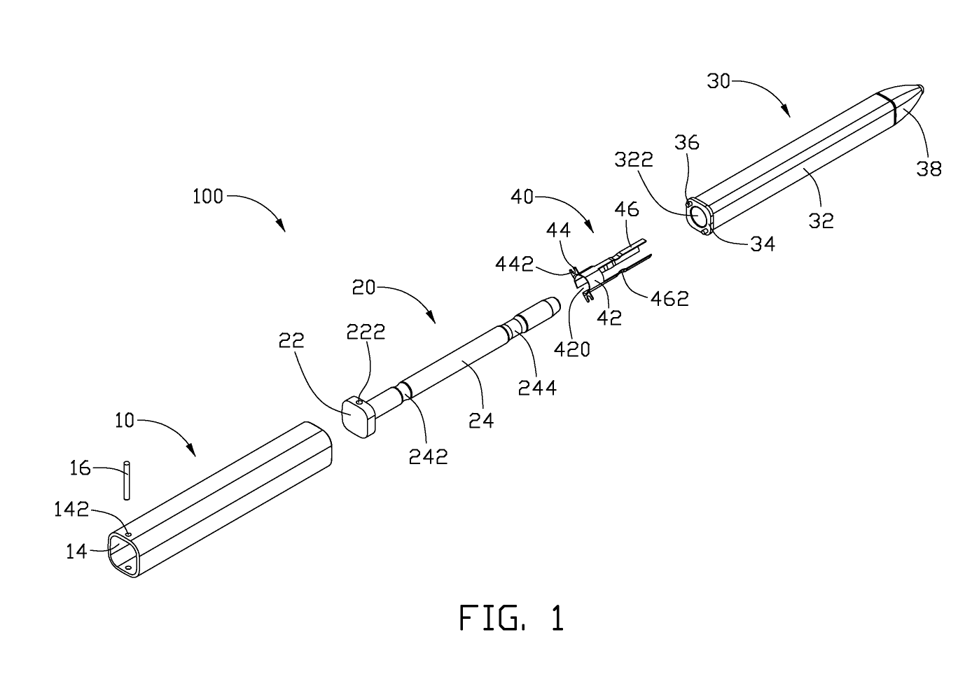

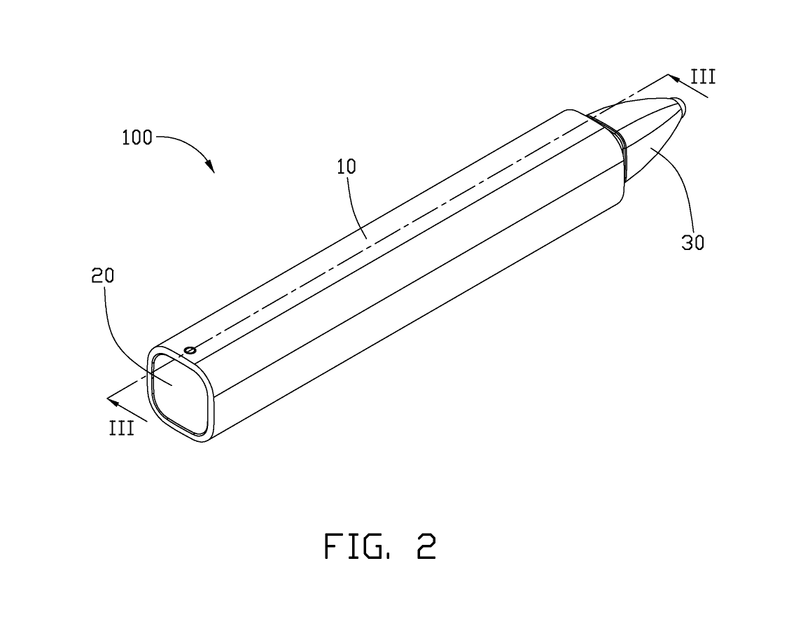

FIGS. 1 and 2 show an exemplary embodiment of a stylus 100 used with a portable electronic device, such as a mobile phone. The stylus 100 includes a housing 10, a pole 20, a core 30, and a positioning member 40. The pole 20 and the core 30 are received in the housing 10. The positioning member 40 is mounted to one end of the core 30 for latching the core 30 in a closed position and a fully extended position relative to the housing 10.

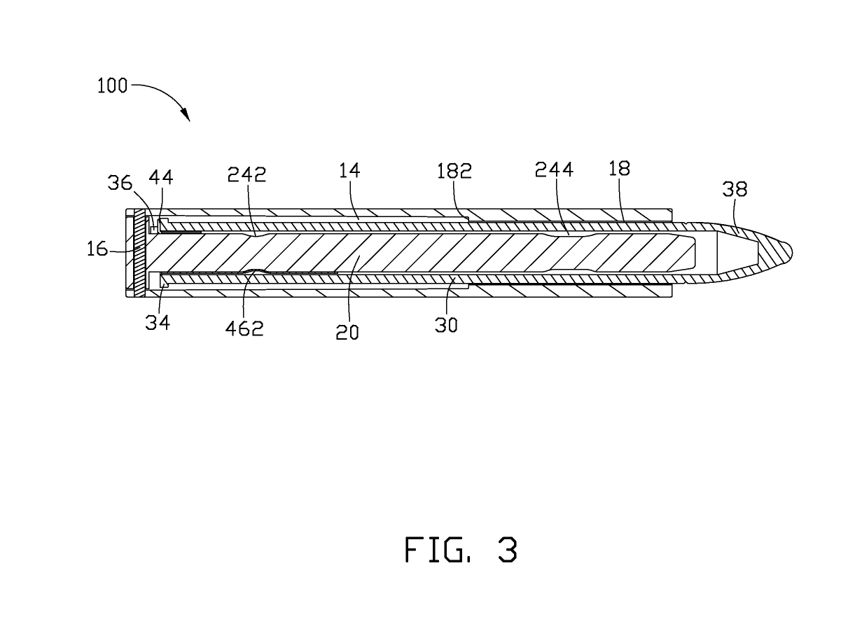

Referring to FIG. 3, the housing 10 is substantially a hollow cylinder, and defines a first receiving cavity 14 and a second receiving cavity 18 that communicate with each other. The first receiving cavity 14 has a larger diameter than the diameter of the second receiving cavity 18. Thus, a step 182 is formed at a connection between the first receiving cavity 14 and the second receiving cavity 18. The housing 10 defines a pair of pin holes 142 at one end of the first receiving cavity 14.

The pole 20 includes a flange portion 22 and a shaft portion 24 integrally formed together. The flange portion 22 defines a through hole 222 communicating two sides of the flange portion 22. The flange portion 22 can be received in the first receiving cavity 14, and a pin 16 can extend through the pin holes 142 and the through hole 222 to secure the pole 20 to the housing 10. The shaft portion 24 can be received in the first receiving cavity 14 and the second receiving cavity 18. The shaft portion 24 defines a first ring groove 242 and a second ring groove 244. The first ring groove 242 is adjacent to the flange portion 22, and a width of the first ring groove 242 is shorter than the width of the second ring groove 244.

The core 30 is substantially a hollow cylinder, and can be slidably received in the housing 10. The core 30 includes a main body 32, a latching portion 34, and a head portion 38. The main body 32 defines a chamber 322 for receiving the shaft portion 24 of the pole 20. The latching portion 34 is substantially ring shaped, and is formed at one end of the main body 32. A cross section of the latching portion 34 is larger than the cross-section of the main body 32. The latching portion 34 can abut against the step 182 of the housing 10 to prevent the movement of the core 30. Two opposite posts 36 respectively axially extend from two sides of the latching portion 34. The head portion 38 is formed at the other end of the main body 32.

The positioning member 40 can be made of sheet metal, and can be secured in the chamber 322 of the core 30. In an exemplary embodiment, the positioning member 40 is received in the chamber 322, and is fixed to an inner wall of the main body 32 by any suitable means know in the art for fixing metal to plastic, e.g. fusion. The positioning member 40 includes a barrel portion 42 with a longitudinal slot 420. The barrel portion 42 may be compressed to be received in the chamber 322 since the longitudinal slot 420 provides space for deformation. Two opposite U-shaped clamping portions 44 radially extend from one end of the barrel portion 42 for clamping onto the posts 36 of the core 30. In an exemplary embodiment, a cutout 442 is defined in the clamping portions 44. A plurality of arms 46 extends from the other end of the barrel portion 42. Each arm 46 has an inwardly projecting arcuate portion 462 at a same distance from the other end of the barrel portion 42. The arcuate portions 462 are for engaging in the first ring groove 242 and the second ring groove 244.

Referring to FIGS. 2-3, when the stylus 100 is assembled, the positioning member 40 is secured in the core 30 by fusion. The arms 46 are received in the chamber 322, and the posts 36 are latched to the cutouts 422 of the clamping portions 44. The shaft portion 24 of the pole 20 is inserted into the chamber 322 with the flange portion 22 adjacent to the latching portion 34. The projections 462 of the arms 46 are latched in the first ring groove 242. After that, the core 30 with the pole 20 is received in the housing 10. The through hole 222 is aligned with the pin hole 10. The pin 16 are inserted into the through hole 222 and the pin hole 10 to fix the pole 20 to the housing 10. The head portion 38 is exposed from the housing 10. Thus, the assembly of the stylus 100 is finished.

In use, the user pulls the head portion 38 of the stylus 100, which causes the core 30 to move the positioning member 40, so that the projections 462 are deformed and move out from the first ring groove 242 until the latching portion 34 abuts against the step 182. The projections 462 are received in the second ring groove 244. Thus, the stylus 100 can be pulled out to a fully extended state. The positioning member 40 may be used to stably position the stylus in different positions, and the size and operation of the stylus can be personalized for comfort of various users.

It is believed that the present embodiments and their advantages will be understood from the foregoing description, and it will be apparent that different changes may be made thereto without departing from the spirit and scope of the invention or sacrificing all of its material advantages, the examples hereinbefore described merely being preferred or exemplary embodiments of the invention.

What is claimed is:

1. A stylus comprising:
a housing;
a core slidably received in the housing;
a pole secured in the housing, the pole including a first ring groove and a second ring groove;
a positioning member mounted to the core, the positioning member forming a plurality of arcuate portions; the arcuate portions selectably engagable in the first ring groove and the second ring groove to position the stylus at different positions.

2. The stylus holding mechanism of claim 1, wherein the positioning member is made of sheet metal, and is fixed to the main body.

3. The stylus holding mechanism of claim 1, wherein the positioning member includes a barrel portion with a longitudinal slot, and the barrel portion is attached to an inner wall of the core.

4. The stylus holding mechanism of claim 3, wherein two opposite clamping portions radially extend from one end of the barrel portion, a cutout is defined in the clamping portions, a plurality of arms extends from the other end of the barrel portion, and the arcuate portions are formed on the arms.

5. The stylus holding mechanism of claim 4, wherein the core includes a latching portion, two opposite posts respectively axially extend from two sides of the latching portion for engaging in the cutouts.

6. The stylus holding mechanism of claim 5, wherein the core includes a main body defining a chamber for receiving the positioning member and the pole, and the latching portion is formed at one end of the main body.

7. A stylus comprising:
a housing;
a core slidably received in the housing;
a pole secured in the housing and received in the core;
a positioning member mounted to the core for positioning the core relative to the housing.

8. The stylus holding mechanism of claim 7, wherein the positioning member is made of sheet metal, and is fixed to the main body by fusion.

9. The stylus holding mechanism of claim 7, wherein the positioning member includes a barrel portion with a longitudinal slot, and the barrel portion is attached to an inner wall of the core.

10. The stylus holding mechanism of claim 9, wherein two opposite clamping portions radially extend from one end of the barrel portion, a cutout is defined in each of the clamping portions, a plurality of arms extends from the other end of the barrel portion, and an arcuate portion is formed on each of the arms.

11. The stylus holding mechanism of claim 10, wherein the core includes a latching portion, two opposite posts respectively axially extend from two sides of the latching portion for engaging in the cutouts.
